(19) United States
(12) Patent Application Publication
(10) Pub. No.: US 2026/0319704 A1
(43) Pub. Date: Oct. 15, 2026

(54) SUB-SECTOR DATA MANAGEMENT FOR A DATA STORAGE DEVICE

(71) Applicant: Sandisk Technologies, Inc., Milpitas, CA (US)

(72) Inventors: Ramanathan Muthiah, Bengalore (IN); Eran Sharon, Rishon Lezion (IL); Judah Gamliel Hahn, Ofra (IL)

(21) Appl. No.: 19/179,972

(22) Filed: Apr. 15, 2025

(51) Int. Cl. G06F 3/06

(52) U.S. Cl. CPC G06F 3/0659; G06F 3/0604; G06F 3/0679

(57) ABSTRACT

A data storage device includes a controller having a first encoding system that encodes/decodes data associated with a first computing device and a second encoding system that encodes/decodes data associated with a second computing device. When a command is received, the controller determines whether the command should be routed to the first encoding system or the second encoding system. When the command is routed to the first encoding system, the controller generates a logical to physical mapping entry having a first granularity. When the command is routed to the second encoding system, the controller generates a logical to physical mapping entry having a second, smaller granularity.

### BACKGROUND

Traditionally, graphics processing units (GPUs) have relied on a host device, to which a data storage device is connected, to initiate access to stored data. However, as technology continues to evolve, there is a growing need to enable the GPU to directly access the data storage device. For example, artificial intelligence applications, real-time analytics, and high-performance computing would benefit from a GPU having direct access to various resources of the data storage device.

However, architectural and operational characteristics of current data storage devices present challenges when providing access to a host device and a GPU. For example, the host device may access sectors of a first size (e.g., four kilobytes (KB)) while a GPU may access sectors of a second size (e.g., sectors less than four KB). However, current data storage device interfaces are primarily designed around the host device. As such, as computation shifts from slower central processing units (CPUs) of the host device to faster GPUs, bottlenecks may arise which negatively impacts the performance of the data storage device.

Accordingly, it would be beneficial for a data storage device to support direct access for a host device and direct access for a non-host device, such as a GPU, without negatively impacting performance characteristics of the data storage device.

### SUMMARY

The present application describes a data storage device, such as a NAND data storage device, that includes a controller having two different encoding systems. As a result, the data storage device can handle commands received from a first computing device, such as a host computing device and handle commands that are received from a second computing device, such as a non-host device or a graphics processing unit (GPU). In an example, the first encoding system is a low-density parity check (LDPC) encoding system that includes a LDCP encoder and a LDPC decoder. The second encoding system is a Bose-Chaudhuri-Hocquenghem (BCH) encoding system that includes a BCH encoder and a BCH decoder.

In an example, the controller receives a command and associated data and determines which encoding system to used based, at least in part, on one or more characteristics associated with the command and/or the data. For example, if the command and/or the data originated from the host device, the first encoding system is used. However, if the command and/or the data originated from the non-host device, the second encoding system is used. Although specific characteristics are mentioned, the controller can determine which encoding system to use based on other characteristics.

In examples in which the second encoding system is used, the controller also generates logical to physical entries for a logical to physical mapping table that are smaller than standard, or typical logical to physical entries (e.g., logical to physical entries that are generated when the data is encoded using the first encoding scheme). For example, when data is encoded using the first encoding scheme, the logical to physical mapping may have a granularity of four (4) kilobytes (KB). However, when the data is encoded using the second encoding scheme, the logical to physical mapping may have a granularity of 256 bytes. Although 4 KB and 256 bytes are specifically mentioned, these are for example purposes only.

Accordingly, examples of the present disclosure describe a method that includes receiving a command and determining one or more characteristics associated with the command. A determination, based at least in part, on the one or more characteristics, is then made as to whether to route data associated with the command to a first encoding system associated with a controller of a data storage device or a second encoding system associated with the controller of the data storage device. When it is determined to route the data to the first encoding system, a first logical to physical entry having a first fragment size (or granularity) is generated and subsequently stored in a logical to physical mapping table. When it is determined to route the data to the second encoding system, a second logical to physical entry having a second fragment size (or granularity) is generated. In an example, the second fragment size is less than the first fragment size. When generated, the second logical to physical entry is stored in the logical to physical mapping table.

Other examples describe a data storage device that includes a controller, a first encoding system and a second encoding system. The data storage device also includes a routing system associated with the controller. In an example, the routing system is operable to determine one or more characteristics associated with a received command. The routing system determines, based, at least in part, on the one or more characteristics, whether to route data associated with the command to the first encoding system or the second encoding system. Based, at least in part, on determining to route the data to the first encoding system, the routing system generates a first logical to physical entry having a first fragment size and stores the first logical to physical entry in a logical to physical mapping table. However, if the routing system determines to route the data to the second encoding system, the routing system generates a second logical to physical entry having a second fragment size. In an example, the second fragment size is less than the first fragment size. The routing system also stores the second logical to physical entry in the logical to physical mapping table.

Still other examples describe a data storage device that includes means for receiving a command and means for determining one or more characteristics associated with the command. The data storage device also includes means for determining whether to route data associated with the command to a first encoding system associated with a controller means or a second encoding system associated with the controller means. The data storage device also includes means for generating a first logical to physical entry having a first fragment size when the data is routed to the first encoding system and means for generating a second logical to physical entry having a second fragment size when the data is routed to the second encoding system. In an example, the second fragment size is less than the first fragment size.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 is a block diagram of a system that includes a host device and a data storage device according to an example.

FIG. 2A illustrates how a memory device includes a number of memory blocks according to an example.

FIG. 2B illustrates how a memory block includes one or more pages according to an example.

FIG. 3 illustrates a memory device having different types of memory blocks according to an example.

FIG. 4A illustrates a system for routing data and/or commands to a particular encoder/decoder according to an example.

FIG. 4B illustrates a logical to physical mapping table that includes sub-sector logical to physical entries and other logical to physical entries according to an example.

FIG. 5 illustrates a method for routing commands and/or data to a particular encoder/decoder according to an example.

FIG. 6 is a perspective view of a storage device that includes three-dimensional (3D) stacked non-volatile memory according to an example.

FIG. 7 is a block diagram of a storage device according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. The following detailed description is therefore not to be taken in a limiting sense, and the scope of the present disclosure is defined by the appended claims and their equivalents.

As previously described, there is a growing need to enable a host device and a non-host device, such as a graphics processing unit (GPU), to have direct access to a data storage device. However, both the host device and the GPU require high-throughput, low-latency access to the data storage device. Traditionally, the architectural and operational characteristics of the data storage device are designed with the host device in mind. As such, when a GPU attempts to access the data storage device, various access issues and/or latency issues may arise.

To address the above, the present application describes a data storage device, such as a NAND data storage device, that includes a controller having two different encoding systems. In an example, the first encoding system is usable by a first computing device, such as a host computing device, and the second encoding system is usable by the second computing device. As will be explained in greater detail herein, the first encoding system is a low-density parity check (LDPC) encoding system that includes a LDCP encoder and a LDPC decoder. The second encoding system is a Bose-Chaudhuri-Hocquenghem (BCH) encoding system that includes a BCH encoder and a BCH decoder.

When the controller receives a command, the controller determines whether the command (or the data associated with the command) should be routed to the first encoding system or the second encoding system. For example, if the command and/or the data originated from the host device, the controller selects the first encoding system. However, if the command and/or the data originated from the non-host device, the controller selects the second encoding system. In an example, the selection of encoding systems is based, at least in part, on one or more characteristics associated with the command.

In an example, when the second encoding system is used, the controller also generates logical to physical entries for a logical to physical mapping table that are smaller than standard, or typical logical to physical entries. For example, when data is encoded using the first encoding scheme, the logical to physical mapping may have a first granularity. However, when the data is encoded using the second encoding scheme, the logical to physical mapping may have a second granularity that is smaller than the first granularity.

Accordingly, many technical benefits may be realized including, but not limited to, enabling a host device and a non-host device to access data stored by the data storage device without negatively impacting latency and throughput and reducing control overhead, write-amplification and control latency by having different logical to physical granularity.

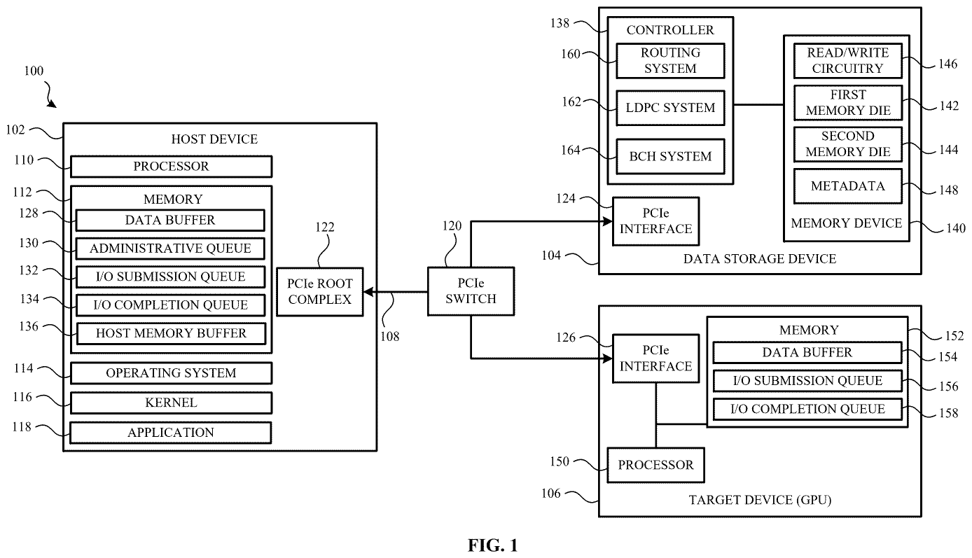

These benefits, along with other examples, will be shown and described in greater detail with respect to FIG. 1-FIG. 7.

FIG. 1 illustrates a block diagram of a system 100 that includes a host device 102, a data storage device 104 and a target device 106. In an example, the host device 102 is communicatively coupled to the data storage device 104 and the target device 106 using a communication interface 108.

In an example, the host device 102 includes at least one processor 110 and a memory 112 (e.g., main memory). The memory 112 includes or is otherwise associated with an operating system 114, a kernel 116 and/or an application 118.

The processor 110 executes various instructions, such as, for example, instructions from the operating system 114 and/or the application 118. The processor 110 includes circuitry such as a microcontroller, a Digital Signal Processor (DSP), an Application-Specific Integrated Circuit (ASIC), a Field Programmable Gate Array (FPGA), hard-wired logic, analog circuitry and/or various combinations thereof. In an example, the processor 110 includes a System on a Chip (SoC).

In an example, the memory 112 is used by the host device 102 to store data used, or otherwise executed by, the processor 110. Data stored in the memory 112 may include instructions provided by the data storage device 104 via the communication interface 108. The data stored in the memory 112 may also include data used to execute instructions from the operating system 114 and/or one or more applications 118. The memory 112 may be a single memory or may include multiple memories, such as, for example, one or more non-volatile memories, one or more volatile memories, or a combination thereof.

In an example, the operating system 114 creates a virtual address space for the application 118 and/or other processes executed by the processor 110. The virtual address space maps to locations in the memory 112. The operating system 114 also includes or is otherwise associated with the kernel 116. The kernel 116 includes instructions for managing various resources of the host device 102 (e.g., memory allocation), handling read and write requests and so on.

As previously described, the communication interface 108 communicatively couples the host device 102, the data storage device 104 and the target device 106. The communication interface 108 may be a Serial Advanced Technology Attachment (SATA), a PCI express (PCIe) bus, a Small Computer System Interface (SCSI), a Serial Attached SCSI (SAS), Ethernet, Fibre Channel, or Wi-Fi. As such, the host device 102 and the data storage device 104 and/or the target device 106 need not be physically co-located and may communicate over a network such as a Local Area Network (LAN) or a Wide Area Network (WAN), such as the internet. In addition, the host device 102 may interface with the data storage device 104 using a logical interface specification such as Non-Volatile Memory express (NVMe) or Advanced Host Controller Interface (AHCI).

In examples in which the communication interface 108 is a PCIe bus, there is a first PCIe link between the data storage device 104 and the host device 102, a second PCIe link between the data storage device 104 and the target device 106, and a third PCIe link between the host device 102 and the target device 106. For example, a PCIe switch 120 communicatively couples the host device 102, the data storage device 104 and the target device 106 using a PCIe root complex 122 in the host device 102, a PCIe interface 124 in the data storage device 104 and a PCIe interface 126 associated with the target device 106. Although a PCIe switch 120 is shown and described, the PCIe switch 120 may be omitted. In other examples, there may be more than one PCIe switch 120.

Additionally, although FIG. 1 shows the PCIe root complex 122 being part of the host device 102, the PCIe root complex 122 may be separate from the host device 102. Likewise, the PCIe interface 124 associated with the data storage device 104 and the PCIe interface 126 associated with the target device may be a part of each device or separate from each device.

In an example, the communication interface 108 may include any number of lanes or connections. Additionally, the lanes or connections between the various devices may be the same or they may vary. For example, the first PCIe link between the data storage device 104 and the host device 102 may have a first number of lanes, the second PCIe link between the data storage device 104 and the target device 106 may had a second number of lanes, and the third PCIe link between the host device 102 and the target device 106 may have a third number of lanes.

As previously described, the host device 102 includes a memory 112. The memory 112 may be DRAM, SRAM, non-volatile memory, or another type of storage. The memory 112 may be used for and/or include various data buffers and queues for the NVMe protocol. For example, the memory 112 may include a data buffer 128. The data buffer 128 stores data to be written to the data storage device 104 and/or stores data that was read from the data storage device 104.

The memory 112 may also include an administrative queue 130, an I/O submission queue 132, and an I/O completion queues. In an example, the administrative queue 130 is used for tasks such as queue creation and deletion, device status interrogation and feature configuration. The I/O submission queue and the I/O completion queue are used for all data storage-related transfers, such as reads and writes. For example, the host device 102 places NVMe commands on the I/O submission queue 132 to instruct a controller 138 of the data storage device 104 to read and/or write data to a memory device 140. In an example, the memory controller 138 also provides a command completion message in the I/O completion queue 134 upon completion of the NVMe command. The controller 138 may also perform a direct memory access (DMA) of data from the data buffer 128 a when writing data to the memory device 140. In another example, the memory controller 138 may perform a DMA of data to the data buffer 128 when reading data from the memory device 140.

In an example, the memory 112 also includes a host memory buffer 136. The host memory buffer 136 is a region of memory 112 that is provided for exclusive use of the data storage device 104. For example, the controller 138 may use the host memory buffer 136 to store a host logical address to physical address translation table (or portion thereof). The physical address is an address in the memory device 140 that corresponds to the host logical address. As such, the controller 138 may access the host memory buffer 136 to execute an NVMe command that specifies a host logical address.

As previously explained, the data storage device 104 includes at least one controller 138 and at least one memory device 140. The controller 138 may be communicatively coupled to the memory device 140. In an example, the data storage device 104 may include multiple controllers and/or multiple memory devices. In such an example, one controller is responsible for executing a first operation or set of operations (e.g., on a first memory device) and a second controller is responsible for executing a second operation or set of operations (e.g., on the first memory device or the second memory device).

In an example, the memory device 140 includes one or more memory dies (e.g., a first memory die 142 and a second memory die 144). Although two memory dies are shown, the memory device 140 may include any number of memory dies (e.g., one memory die, two memory dies, eight memory dies, or another number of memory dies). Additionally, although memory dies are specifically mentioned, the memory device 140 may include any non-volatile memory device, storage device, storage elements or storage medium including NAND flash memory cells and/or NOR flash memory cells.

In an example, one or more of the first memory die 142 and the second memory die 144 include one or more memory blocks. In an example, each memory block includes one or more memory cells. A block of memory cells is the smallest number of memory cells that are physically erasable together. The memory cells can be one-time programmable, few-time programmable, or many-time programmable. Additionally, the memory cells may be single-level cells (SLCs), multi-level cells (MLCs), triple-level cells (TLCs), quad-level cells (QLCs), penta-level cells (PLCs), and/or use any other memory technologies. The memory cells may be arranged in a two-dimensional configuration or a three-dimensional configuration.

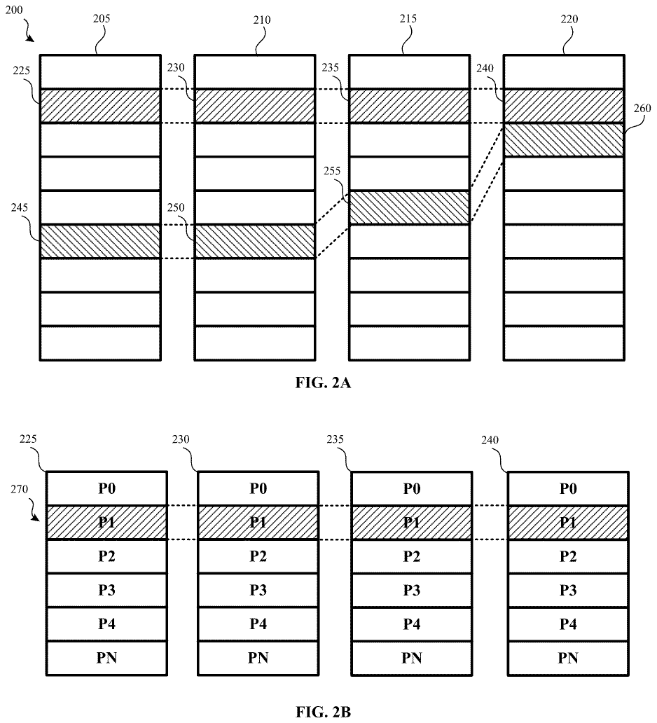

For example and referring to FIG. 2A, FIG. 2A illustrates how a memory device 200 includes a number of memory blocks according to an example. In this example, the memory device 200 (e.g., a storage element, a memory die, a non-volatile memory device) includes four planes or sub-arrays (e.g., a first plane 205, a second plane 210, a third plane 215, and a fourth plane 220). In an example, the planes are integrated on a single memory die. In another example, the planes are provided on two different memory dies (e.g., two planes on each memory die). In yet another example, the planes are provided on four separate memory dies. Although four planes are shown and described, the memory device 200 may have any number of planes and/or memory dies.

In an example, each plane is divided into memory blocks consisting of memory cells.

As shown in FIG. 2A, the rectangles represent a memory block, such as memory block 225, memory block 230, memory block 235 and memory block 240. There may be any number of memory blocks in each plane of the memory device 200. In an example, each memory block is a unit of erase and is sometimes referred to as an erase block. For example, memory block 225, memory block 230, memory block 235 and memory block 240 include a minimum number of memory cells that are erased together.

In an example, various memory blocks are logically linked or grouped together (e.g., using a table in, or otherwise accessible by, the controller 138 (FIG. 1)) to form a metablock. A metablock is written to, read from and/or erased as a single unit. For example, memory block 225, memory block 230, memory block 235 and memory block 240 form a first metablock while memory block 245, memory block 250, memory block 255 and memory block 260 form a second metablock. The memory blocks used to form a metablock need not be restricted to the same relative locations within their respective planes.

As previously described, each memory block is divided, for operational purposes, into pages of memory cells. For example and referring to FIG. 2B, FIG. 2B illustrates how a memory block includes one or more pages according to an example. For example, the memory cells of memory block 225, memory block 230, memory block 235 and memory block 240 are divided into N different pages (shown as P0-PN). Although a specific number of pages are shown in FIG. 2B, a memory block may have any number of pages of memory cells. Further, a memory block, such as a TLC memory block, may include an upper page, a middle page and a lower page.

In an example, a page is a unit of data programming within the memory block. Each page includes the minimum amount of data that can be programmed at one time. The minimum unit of data that can be read at one time may be less than a page. For example, each page is further dividable into segments or units and each segment includes the fewest number of memory cells that may be written to at one time as a basic programming operation.

A metapage 270 is illustrated in FIG. 2B as being formed of one physical page from each of memory block 225, memory block 230, memory block 235 and memory block 240. In the example, shown, the metapage 270 includes page P1 in each of the four memory blocks.

However, the pages of the metapage 270 need not have the same relative position within each of the memory blocks. A metapage 270 may be the maximum unit of programming within a memory block.

The memory blocks disclosed in FIG. 2A-FIG. 2B are referred to herein as physical memory blocks because they relate to groups of physical memory cells. A logical memory block is a virtual unit of address space defined to have the same size as a physical memory block. Each logical memory block includes a range of logical memory block addresses (LBAs) that are associated with data received from a host. The LBAs are then mapped to one or more physical memory blocks in a data storage device where the data is physically stored.

Referring back to FIG. 1, in an example, the data storage device 104 and/or the memory device 140 includes, or is otherwise associated with, different types of memory blocks. For example, each of the first memory die 142 and the second memory die 144 may include SLC memory blocks, TLC memory blocks and/or hybrid memory blocks. Although TLC memory blocks are specifically mentioned, each memory die can include MLC memory blocks, QLC memory blocks, PLC memory blocks or a memory block that can store any number of bits per cell.

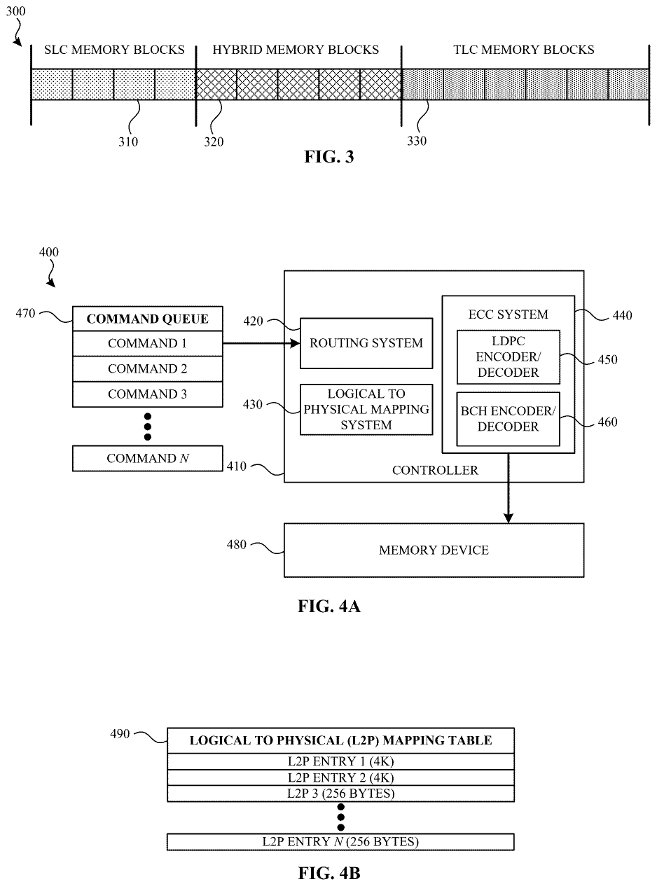

For example, and referring to FIG. 3, FIG. 3 illustrates a memory device 300 having different types of memory blocks according to an example. In an example, the memory device 300 is similar to the memory device 140 shown and described with respect to FIG. 1. As previously indicated, the memory device 300 includes a first type of memory block, such as, for example, SLC memory blocks 310. The memory device 300 also includes a second type of memory block, such as, for example, hybrid memory blocks 320. The memory device 300 can also include a third type of memory block, such as, for example, TLC memory blocks 330. The hybrid memory blocks 320 can operate in a first mode or can operate as a first type of memory block (e.g., operate in a SLC mode or operate as a SLC memory block) and operate in a second mode or operate as a second type of memory block (e.g., operate in a TLC mode or operate as a TLC memory block). Although a specific number of memory blocks is shown, each partition of the memory device 300 may include any number of memory blocks.

Referring back to FIG. 1, in some examples, the data storage device 104 is attached to, or embedded within, the host device 102. In another example, the data storage device 104 may be implemented as an external device or a portable device that can be communicatively or selectively coupled to the host device 102. In yet another example, the data storage device 104 is a component (e.g., a solid-state drive (SSD)) of a network accessible data storage system, a network-attached storage system, a cloud data storage system, and the like.

The memory device 140 may also include support circuitry. In an example, the support circuitry includes read/write circuitry 146. The read/write circuitry 146 supports the operation of the memory dies of the memory device 140. Although the read/write circuitry 146 is depicted as a single component, the read/write circuitry 146 may be divided into separate components, such as, for example, read circuitry and write circuitry. The read/write circuitry 146 may be external to the memory dies of the memory device 140. In another example, one or more of the memory dies may include corresponding read/write circuitry 146 that is operable to read data from and/or write data to storage elements within one individual memory die independent of other read and/or write operations on any of the other memory dies.

The memory device 140 may also store metadata 148. As will be explained in greater detail herein, the metadata 148 includes information about the memory device 140 and/or information about each of the first memory die 142 and/or the second memory die 144. For example, the metadata 148 indicates a type of encoding (e.g., low-density parity check (LDPC) encoding/decoding or Bose-Chaudhuri-Hocquenghem (BCH) encoding/decoding) that was used to encode and/or store data in the various memory dies and/or a type of decoding that will be used to read and/or decode the data from the memory dies.

As previously described, the data storage device 104 includes at least one controller 138. The controller 138 is communicatively coupled to the memory device 140 via a bus, an interface or other communication circuitry. In an example, the communication circuitry includes one or more channels which enable the controller 138 to communicate with the first memory die 142 and/or the second memory die 144 of the memory device 140. In another example, the communication circuitry includes multiple distinct channels which enables the controller 138 to communicate with the first memory die 142 independently and/or in parallel with the second memory die 144 of the memory device 140.

In an example, the target device 106 is a is a graphics processing unit (GPU). Although a GPU is specifically mentioned, the target device 106 may be any type of device. In an example, the target device 106 is a NVMe co-host. As such, the target device 106 is able to issue NVMe commands (e.g., storage commands) to the data storage device 104. Although a single target device 106 is shown and described, the system 100 may include any number of target devices.

In an example, the target device 106 includes a processor 150 or a controller, a memory 152, and the PCIe interface 126. The processor 150, the memory 152 and/or the PCIe controller are communicatively coupled using a bus or other communication channel. In an example, the memory 152 is the physical memory of the target device 106 and can be DRAM, SRAM, non-volatile memory, or another type of storage device. In an example, the target device 106 is external to and separate from the data storage device 104. In another example, the target device 106, or various components of the target device 106, is part of, or otherwise associated with, the data storage device 104.

In an example, and like the memory 112 of the host device 102, the memory 152 of the target device 106 includes a data buffer 154, an I/O submission queue 156 and an I/O completion queue 158. The target device 106 uses the various queues to issue NVMe commands (e.g., storage commands) to the data storage device 104.

In an example, the data storage device 104 provides or writes a command completion status to the I/O completion queue 158. In an example, the host device 102 may create the various queues in the target device 106. In an example, and once the queues are created, the host device 106 can communicate memory allocation details to the target device 106. The target device 106 can then autonomously execute NVMe commands.

The data buffer 154 in the target device 106 may be used to store data that is to be written directly to the data storage device 104 and/or to store data that was read from the memory device 140. In an example, the controller 138 of the data storage device 104 may perform a DMA of data from the data buffer 154 a when writing data to the data storage device 104.

The controller 138 may perform a DMA of data to the data buffers 154 when reading data from the memory device 140.

In an example, the system 100 uses DMA to access the memory 112 and the memory 152 of the target device 106. Additionally, the data storage device 104 communicates with the other devices using a common address space. For example, the data storage device 104 communicates with the host device 102 and/or the target device 106 using a PCIe address space. In an example, each PCIe device may be assigned a range of addresses in the PCIe address space. However, the internal (or local) memory addresses used by the PCIe devices may be different from the PCIe address space. Hence, there is typically a need to translate between the PCIe address space and the internal memory addresses.

In an example, the PCIe root complex 122 provides address translation services in order to redirect DMA transactions from one device to another device as needed. In some examples, the transactions are directed to the various devices without the need for a buffer within the memory 112 of the host device 102. For example, when the system 100 issues a transaction on a PCIe link to access memory in either the host device 102 or the target device 106, the system 100 includes an address in the PCIe address space in a packet that it transmits on a PCIe link. The PCIe root complex 122 performs PCIe address translation upon receiving the packet. That is, the PCIe root complex 122 translates the PCIe address in the transaction from the system 100 to a physical (or internal) address in the target (e.g., host device 102, target device 106). Additional examples may be found in U.S. Pat. No. 11,561,909, entitled “Bandwidth Allocation for Storage System Commands in Peer-to-Peer Environment”, which is hereby incorporated by reference in its entirety.

As previously explained, the target device 106 may be a GPU. Additionally, the GPU may have direct access to the memory device 140 of the data storage device 104. For example, the GPU may be directly connected to one or more SLC memory blocks (e.g., SLC memory blocks 310 (FIG. 3)) of one or more of the first memory die 142 and/or the second memory die 144. However, the GPU may have access requirements that that are different from the host device 102. For example, the host device 102 may have a first access requirement while the GPU has a second access requirement.

For example, the first access requirement may indicate that four kilobyte (4 KB) fragments, or flash management units (FMUs), be used when accessing the data storage device 104. In such an example, the 4 KB fragment is comprised of eight sectors and each sector has 512 bytes. In an example, at least one sector is a logical block address (LBA). Although a specific number of sectors and bytes are mentioned, these are for example purposes only.

However, the second access requirement may indicate that sub-fragments, or sub-sectors, be used when accessing the data storage device 104. In an example, the sub-fragments, or sub-sectors, may be 256 bytes. Although a specific number of bytes has been mentioned, the sub-fragment may be larger than 256 bytes or smaller than 256 bytes. In examples, in which the data storage device 104 supports multiple access requirements, the data storage device 104 includes a routing system 160.

In an example, the routing system 160 is part of, or otherwise associated with, the controller 138. Although the routing system 160 is shown as part of the controller 138, the routing system 160 may be separate from the controller 130. Additionally, the routing system 160 may be packaged functional hardware units designed for use with other components/systems, a portion of a program code (e.g., software or firmware) executable by the controller 138, a processor and/or processing circuitry, or a self-contained hardware and/or software component that interfaces with other components and/or systems.

The routing system 160 is configured and/or operable to evaluate one or more commands in a command queue. In an example, the commands in the command queue may be read commands, write commands, erase commands or other types of commands. Additionally, the commands in the command queue may originate from the host device 102 or may originate from the target device 106 (or the GPU).

When a command is received and provided to the controller 138, the routing system 160 determines how data associated with the command should be routed. For example, if the command and/or the data associated with the command is subject to the first access requirement, the routing system 160 routes the data to a first encoding/decoding system associated with the controller 138. In an example, the first encoding/decoding system is a LDPC encoder and decoder and is shown in FIG. 1 as a LDPC system 162.

However, if the routing system 160 determines that the command and/or the data associated with the command is subject to the second access requirement, the routing system 160 routes the data to a second encoding/decoding system associated with the controller 138. In an example, the second encoding/decoding system is a BCH encoder and decoder. In FIG. 1, the second encoding/decoding system is shown as BCH system 164.

In an example, the routing system 160 determines where to route the data and/or the command based, at least in part, on determining where the data and/or the command originated. For example, if the command and/or the data originated from the host device 102, the routing system 160 may determine that the command and/or the data should be handled by the LDPC system 162. However, if the data and/or the command originated from the target device 106, the routing system 160 may determine that the data and/or the command should be handled by the BCH system 164.

In another example, the routing system 160 may analyze the data and/or the command to determine a workload associated with command and route the command/data accordingly. In another example, the routing system 160 may analyze the data and/or the command to determine a transaction latency associated with the data and/or the command and route the data/command accordingly. In yet another example, the routing system 160 may route the data and/or the command based on one or more hints provided by a data set management (DSM) feature of the system 100 and/or the host device 102.

When the routing system 160 determines the access policy associated with the data and/or the command (or the routing system 160 determines that a logical group is associated with the target device 106 and/or the target device has the second access requirements), the routing system 160 routes the command and/or the data to the BCH system 164. The data is then encoded (or decoded) with a particular granularity using the BCH system 164.

In an example, the routing system 160 also creates or generates granular logical to physical (L2P) mapping entries for the commands and/or the data that was routed to the BCH system 164. In an example, the routing system 160 creates the entries at a sub-sector level so that the individual sub-sectors can be written without a read modify write (RMW).

Referring back to the example, if the routing system 160 determines that the access policy associated with the data and/or the command is the first access policy (or is associated with a particular partition in the memory device 140 (e.g., a TLC partition)), the routing system 160 routes the command and/or the data to the LDPC system 162. The data is then encoded (or decoded) using standard LDPC encoding and/or L2P management.

In an example, when the data is encoded, either using the LDPC system 162 or the BCH system 164, the encoded data is routed to a particular partition of the memory device 140. For example, if data is encoded using BCH encoding, the data is routed to a first partition (e.g., a partition that includes SLC memory blocks). However, if the data is encoded using LDPC encoding, the data is routed to a second partition (e.g., a partition that includes MLC/TLC/QLC/PLC memory blocks). In an example, the first partition is more suitable for byte-wise granularity access due to short read latency and lower error rates when compared to the second partition. However, the second partition may exhibit higher error rates, which may require stronger ECC schemes such as LDPC.

As previously explained, the memory device 140 may store metadata 148 that indicates what system was used to encode the data and/or the access policy that was associated with the received command and/or the data. Thus, when a decoding operation on stored data is initiated, the data can be routed to the same the same system that encoded the data.

For example, the routing system 160 routes requested data to either the LDPC system 162 or the BCH system 164 to decode the data. For example, the routing system 160 routes the requested data that is to be decoded to the same system that encoded the data. In another example, the routing system 160, or the LDPC system 162, performs a 4 KB fragment decode on data that was encoded by the LDPC system 162. In such examples, the LDPC system extracts the required bytes (e.g., 256 bytes) and transfers only the bytes requested by a received command.

The routing system 160 may also discard the rest of the data (e.g., any data that remains in a latch of one or more of the memory dies).

FIG. 4A illustrates a system 400 for routing data and/or commands to a particular encoder/decoder according to an example. In an example, the system 400 may be similar to, or have similar systems to, the various systems shown and described with respect to FIG. 1. For example, the system 400 includes a controller 410. The controller 410 may be similar to the controller 138 shown and described with respect to FIG. 1.

In an example, the controller 410 includes a routing system 420. The routing system 420 may be similar to the routing system 160 shown and described with respect to FIG. 1. The controller 410 may also include or otherwise be associated with a logical to physical mapping system 430. The controller 410 may also include, or otherwise be associated with, an error correction code (ECC) system 440. The ECC system 440 includes a first encoder/decoder (e.g., a LCPC encoder/decoder 450) and a second encoder/decoder (e.g., a BCH encoder/decoder 460).

The controller 410 is operable to receive one or more commands from a command queue 470. In the example shown, the command queue 470 includes N commands (e.g., Command 1 through Command N). One or more of the commands in the command queue 470 may be associated with data. Additionally, each command in the command queue 470 may be associated with a host device (e.g., the host device 102 (FIG. 1)) or a GPU (e.g., the target device 106 (FIG. 1)).

When a command, such as Command 1, is received by the controller 410, the controller 410 and/or the routing system 420 analyzes one or more characteristics associated with Command 1 to determine to which encoder/decoder Command 1 and/or the data associated Command 1 should be routed. In one example, the one or more characteristics is a logical block address (LBA) associated with Command 1 and/or the data associated with Command 1.

If the routing system 420 determines that the LBA associated with the data and/or Command 1 is associated with the GPU, the data and/or Command 1 will be routed to the BCH encoder/decoder 460. However, if the routing system 420 determines that the LBA associated with the data and/or Command 1 is not associated with the GPU (e.g., the data and/or the command is associated with the host device), the data and/or Command 1 will be routed to the LDPC encoder/decoder 450.

In another example, the one or more characteristics associated with Command 1 may be an access requirement. If the routing system 420 determines that Command 1 has, or is associated with, a first access requirement (e.g., an access requirement that specifies that 4 KB fragments are accessed or used), the routing system 420 will route data associated with Command 1 to the LDPC encoder/decoder 450. However, if the routing system 420 determines that Command 1 has, or is associated with, a second access requirement (e.g., an access requirement that specifies that sub-fragments are accessed or used), the routing system 420 will route data associated with Command 1 to the BCH encoder/decoder 460.

Although specific examples are given, the routing system 420 is operable to route data and/or commands based on other characteristics. For example, the routing system 420 may route data and/or commands to a particular encoder/decoder based on a PCIe transaction latency (such as those described with respect to U.S. Pat. No. 11,561,909). In yet another example, the routing system 420 is operable to route data and/or commands to a particular encoder/decoder based on one or more hints provided by the host device.

In yet another example, when the routing system 420 determines that a received command is associated with a logical region that is associated with the GPU, the routing system 420 adjusts or modifies resource sharing principles to bias a specific logical region that is associated with the GPU. For example, the routing system 420 increases resource credits to the GPU and the associated region when compared to resource credits allocated to the host device. In an example, this bias may be based, at least in part, on an address associated with the command.

In an example, when the data associated with Command 1 has been routed to the particular encoder/decoder, the logical to physical mapping system 430 generates a logical to physical mapping having a granularity associated with the particular encoder. For example, if the data associated with Command 1 is encoded using the LDPC encoder/decoder 450, the logical to physical mapping system 430 generates or creates a standard logical to physical mapping entry in a logical to physical mapping table. For example, a granularity of the logical to physical mapping entry is based, at least in part, on a chunk size of the LDPC encoder/decoder.

For example and referring to FIG. 4B, FIG. 4B illustrates a logical to physical mapping table 490 that includes sub-sector logical to physical entries and other logical to physical entries according to an example. Thus, when the logical to physical mapping system 430 generates a standard logical to physical mapping entry, the logical to physical mapping entry is stored in the logical to physical mapping table 490 (e.g., as L2P Entry 1).

Referring back to FIG. 4A, if the data associated with Command 1 is encoded using the BCH encoder/decoder 460, the logical to physical mapping system 430 generates or creates a granular logical to physical mapping entry. In an example, the granular logical to physical mapping entry has a size that matches the second access requirement. For example, if the second access requirement is 256 bytes, the granularity of the granular logical to physical mapping entry is 256 bytes. As such, individual sub-sectors can be written without a read modify write. For example, if the granularity of the logical to physical mapping is aligned with an encoding size, the read modify write can be avoided.

For example and referring back to FIG. 4B, when the logical to physical mapping system 430 generates a granular logical to physical mapping entry, the granular logical to physical mapping entries are stored in the logical to physical mapping table 490. As shown in FIG. 4B, the logical to physical mapping table 490 may include N number entries with some of the entries having a 4K granularity while other entries have a 256 byte granularity. Although specific sizes are shown and described, there are for example purposes only.

Referring again to FIG. 4A, when the logical to physical mapping entries have been generated and stored (e.g., in the logical to physical mapping table 490 (FIG. 4B)), the controller 410 (or the ECC system 440) routes the encoded data to the memory device 480. In an example, the controller 410 routes the data to a particular partition or section within the memory device 480 based, at least in part, on how the data was encoded. For example, if the data associated with Command 1 was encoded with the LDPC encoder/decoder, the data is routed to a MLC, a TLC, a QLC or a PLC partition of the memory device 480. However, if the data associated with Command 1 was encoded with the BCH encoder/decoder 460, the data is routed to a SLC partition of the memory device 480. This process may be repeated for the other commands (e.g., Command 2, Command 3, Command N) in the command queue 470.

In some examples, the controller 410 and/or the routing system 420 may bias a cache reservation policy such that the logical to physical pages associated with a logical region to which the GPU is associated with are not swapped with the same frequency other logical to physical pages during a logical to physical swap-in and out state-machine when a system (e.g., the system 100 (FIG. 1)) cannot cache all the logical to physical pages specified by a capacity range. For example, logical to physical pages associated with the GPU may be swapped out less frequently when compared with logical to physical pages associated with the host device.

In an example, positively biasing the cache reservation for logical to physical pages associated to the GPU, and not swapping out the logical to physical pages associated with the GPU, enhances the overall compute quality of service (QOS) of the system. In another example, the controller 410 may also positively bias other pages associated with the GPU, such as P2L pages of GPU metablocks.

In yet another example, AIPR logic associated with the memory device 480 may be tweaked to operate at a flash translation layer chunk level. For example, multiple 4 KB fragments may be retrieved across one or more planes in the memory die and a required number of bytes (e.g., 256) are extracted from multiple different offsets from those retrieved fragments. In such an example, particular chunks (e.g., multiple 256 byte chunks from multiple 4 KB fragments) are extracted and sent to a host device.

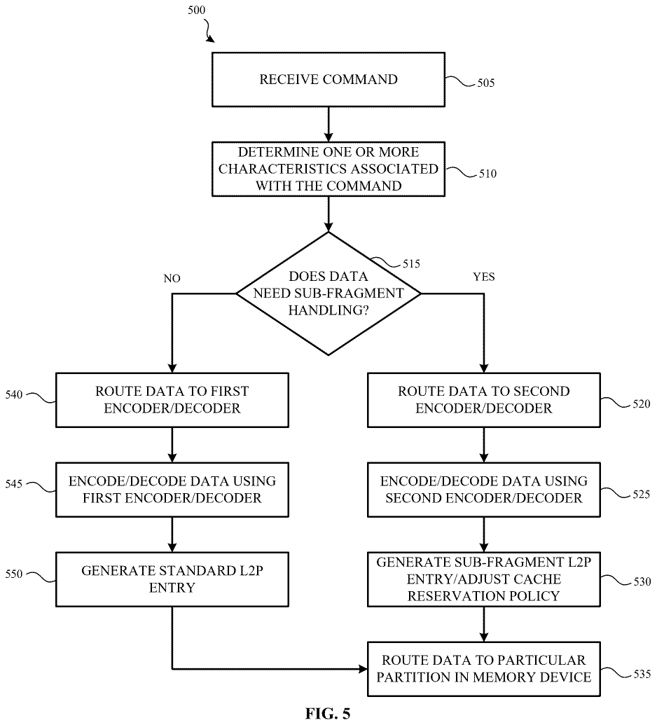

FIG. 5 illustrates a method 500 for routing commands and/or data to a particular encoder/decoder according to an example. In an example, the method 500 is executed by a controller of a data storage device such as, for example, the controller 138 shown and described with respect to FIG. 1.

In an example, the method 500 begins when a command is received (505). In an example, the command may be any type of command. Additionally, the command may be received from a host device, a GPU and/or may be received from a command queue. In another example, the method 500 begins when a certain logical region is mapped to a GPU and another region is mapped to a host device in a pre-determined way in a customized data storage device. In such an example, the data storage device can determine which commands are received from the GPU and initiate the method 500 accordingly.

When the command is received, a controller of the data storage device analyzes the command to determine (510) one or more characteristics associated with command. In an example, the one or more characteristics may be a LBA or a logical region associated with the data and/or the command. In another example, the one or more characteristics may be an access requirement. In another example, the one or more characteristics may be a PCIe transaction latency. In yet another example, the one or more characteristics may be based, at least in part, on one or more hints provided by a host device.

In an example, and based, at least in part, on the controller determining one or more characteristics associated with the command, the controller determines (515) whether data associated with the command needs sub-fragment handling. If the controller determines (515) that the data and/or the command does not need sub-fragment handling, the controller routes (540) the data and/or the command to a first encoder/decoder. In an example, the first encoder/decoder is a LDPC encoder/decoder. The first encoder then encodes or decodes the data associated with the command using (545) the first encoder/decoder. The controller may also generate (550) a standard logical to physical mapping entry in a logical to physical mapping table.

The data is then routed (535) to a particular partition in a memory device. In an example, the data is routed to a MLC, a TLC, a QLC, or a PLC partition in the memory device. Although specific partitions are mentioned, other partitions of the memory device may be used.

However, if the controller determines (515) that the data associated with the command needs sub-fragment handling, the controller routes (520) the data and/or the data associated with a second encoder/decoder. In an example, the second encoder/decoder is a BCH encoder/decoder. The data and/or the command is then encoded or decoded (525) using the second encoder/decoder.

The controller also generates (530) a granular logical to physical mapping entry for a logical to physical mapping table. In an example, the granular logical to physical mapping entry has a size that matches a second access requirement associated with the data. For example, if the access requirement associated with the data is 256 bytes, the granularity of the granular logical to physical mapping entry is 256 bytes. In an example, the controller may also bias a cache reservation policy of the logical to physical entries such as previously described. Although adjusting a cache reservation policy is specifically mentioned, the controller may bias other resources and/or operations in favor of the sub-fragment logical to physical entries such as described herein.

When the logical to physical mapping entry has been generated, the controller routes (535) the encoded data to a particular partition of the memory device such as previously described.

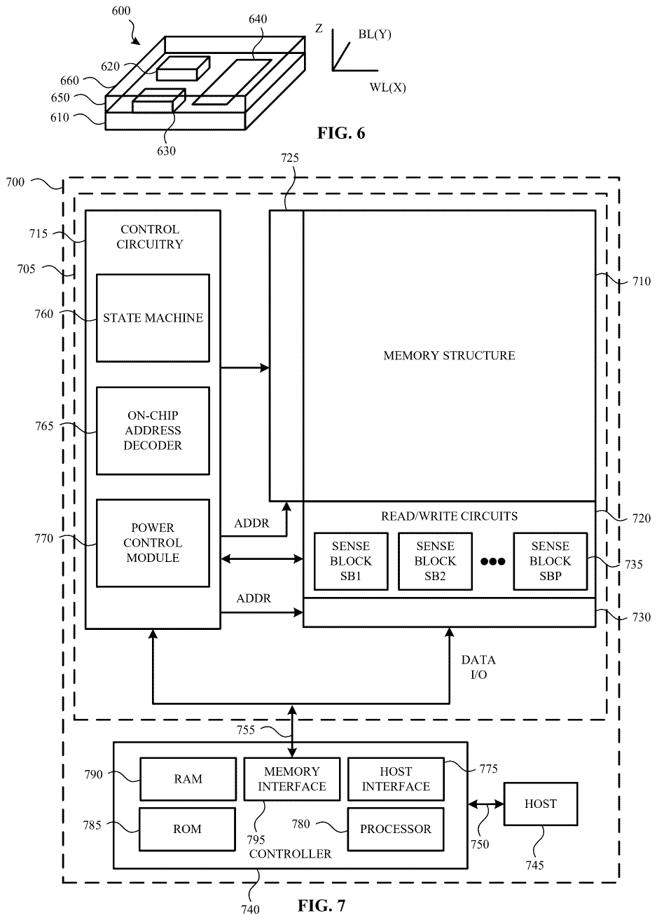

FIG. 6-FIG. 7 describe example storage devices that may be used with or otherwise implement the various features described herein. For example, the storage devices shown and described with respect to FIG. 6-FIG. 7 may include various systems and components that are similar to the systems and components shown and described with respect to FIG. 1. For example, the controller 740 shown and described with respect to FIG. 7 may be similar to the controller 138 of FIG. 1. Likewise, the memory dies 705 may be similar to the first memory die 142 and/or the second memory die 144 of FIG. 1.

FIG. 6 is a perspective view of a storage device 600 that includes three-dimensional (3D) stacked non-volatile memory according to an example. In this example, the storage device 600 includes a substrate 610. Blocks of memory cells are included on or above the substrate 610. The blocks may include a first block (BLK0 620) and a second block (BLK1 630). Each block may be formed of memory cells (e.g., non-volatile memory elements). The substrate 610 may also include a peripheral area 640 having support circuits that are used by the first block and the second block.

The substrate 610 may also carry circuits under the blocks, along with one or more lower metal layers which are patterned in conductive paths to carry signals from the circuits. The blocks may be formed in an intermediate region 650 of the storage device 600. The storage device may also include an upper region 660. The upper region 660 may include one or more upper metal layers that are patterned in conductive paths to carry signals from the circuits. Each block of memory cells may include a stacked area of memory cells. In an example, alternating levels of the stack represent word lines. While two blocks are depicted, additional blocks may be used and extend in the x-direction and/or the y-direction.

In an example, a length of a plane of the substrate 610 in the x-direction represents a direction in which signal paths for word lines or control gate lines extend (e.g., a word line or drain-end select gate (SGD) line direction) and the width of the plane of the substrate 610 in the y-direction represents a direction in which signal paths for bit lines extend (e.g., a bit line direction). The z-direction represents a height of the storage device 600.

FIG. 7 is a functional block diagram of a storage device 700 according to an example. The components depicted in FIG. 7 may be electrical circuits. In an example, the storage device 700 includes one or more memory dies 705. Each memory die 705 includes a three-dimensional memory structure 710 of memory cells (e.g., a 3D array of memory cells), control circuitry 715, and read/write circuits 720. In another example, a two-dimensional array of memory cells may be used. The memory structure 710 is addressable by word lines using a first decoder 725 (e.g., a row decoder) and by bit lines using a second decoder 730 (e.g., a column decoder). The read/write circuits 720 may also include multiple sense blocks 735 including SB1, SB2, . . . , SBp (e.g., sensing circuitry) which allow pages of the memory cells to be read or programmed in parallel. The sense blocks 735 may include bit line drivers.

In an example, a controller 740 is included in the same storage device 700 as the one or more memory dies 705. In another example, the controller 740 is formed on a die that is bonded to a memory die 705, in which case each memory die 705 may have its own controller 740. In yet another example, a controller die controls all of the memory dies 705.

Commands and data may be transferred between a host 745 and the controller 740 using a data bus 750. Commands and data may also be transferred between the controller 740 and one or more of the memory dies 705 by way of lines 755. In one example, the memory die 705 includes a set of input and/or output (I/O) pins that connect to lines 755.

The memory structure 710 may also include one or more arrays of memory cells. The memory cells may be arranged in a three-dimensional array or a two-dimensional array. The memory structure 710 may include any type of non-volatile memory that is formed on one or more physical levels of arrays of memory cells having an active area disposed above a silicon substrate. The memory structure 710 may be in a non-volatile memory device having circuitry associated with the operation of the memory cells, whether the associated circuitry is above or within the substrate.

The control circuitry 715 works in conjunction with the read/write circuits 720 to perform memory operations (e.g., erase, program, read, and others) on the memory structure 710. The control circuitry 715 may include registers, ROM fuses, and other devices for storing default values such as base voltages and other parameters.

The control circuitry 715 may also include a state machine 760, an on-chip address decoder 765 and a power control module 770. The state machine 760 may provide chip-level control of various memory operations. The state machine 760 may be programmable by software. In another example, the state machine 760 does not use software and is completely implemented in hardware (e.g., electrical circuits).

The on-chip address decoder 765 may provide an address interface between addresses used by host 745 and/or the controller 740 to a hardware address used by the first decoder 725 and the second decoder 730.

The power control module 770 may control power and voltages that are supplied to the word lines and bit lines during memory operations. The power control module 770 may include drivers for word line layers in a 3D configuration, select transistors (e.g., SGS and SGD transistors) and source lines. The power control module 770 may include one or more charge pumps for creating voltages.

The control circuitry 715, the state machine 760, the on-chip address decoder 765, the first decoder 725, the second decoder 730, the power control module 770, the sense blocks 735, the read/write circuits 720, and/or the controller 740 may be considered one or more control circuits and/or a managing circuit that perform some or all of the operations described herein.

In an example, the controller 740, is an electrical circuit that may be on-chip or off-chip. Additionally, the controller 740 may include one or more processors 780, ROM 785, RAM 790, memory interface 795, and host interface 775, all of which may be interconnected. In an example, the one or more processors 780 is one example of a control circuit. Other examples can use state machines or other custom circuits designed to perform one or more functions.

Devices such as ROM 785 and RAM 790 may include code such as a set of instructions. One or more of the processors 780 may be operable to execute the set of instructions to provide some or all of the functionality described herein.

Alternatively or additionally, one or more of the processors 780 may access code from a memory device in the memory structure 710, such as a reserved area of memory cells connected to one or more word lines. The memory interface 795, in communication with ROM 785, RAM 790, and one or more of the processors 780, may be an electrical circuit that provides an electrical interface between the controller 740 and the memory die 705. For example, the memory interface 795 may change the format or timing of signals, provide a buffer, isolate from surges, latch I/O, and so forth.

The one or more processors 780 may issue commands to control circuitry 715, or any other component of memory die 705, using the memory interface 795. The host interface 775, in communication with the ROM 785, the RAM 790, and the one or more processors 780, may be an electrical circuit that provides an electrical interface between the controller 740 and the host 745. For example, the host interface 775 may change the format or timing of signals, provide a buffer, isolate from surges, latch I/O, and so on. Commands and data from the host 745 are received by the controller 740 by way of the host interface 775. Data sent to the host 745 may be transmitted using the data bus 750.

Multiple memory elements in the memory structure 710 may be configured so that they are connected in series or so that each element is individually accessible. By way of a non-limiting example, flash memory devices in a NAND configuration (e.g., NAND flash memory) typically contain memory elements connected in series. A NAND string is an example of a set of series-connected memory cells and select gate transistors.

A NAND flash memory array may also be configured so that the array includes multiple NAND strings. In an example, a NAND string includes multiple memory cells sharing a single bit line and are accessed as a group. Alternatively, memory elements may be configured so that each memory element is individually accessible (e.g., a NOR memory array). The NAND and NOR memory configurations are examples and memory cells may have other configurations.

The memory cells may be arranged in the single memory device level in an ordered array, such as in a plurality of rows and/or columns. However, the memory elements may be arrayed in non-regular or non-orthogonal configurations, or in structures not considered arrays.

In an example, a 3D memory structure may be vertically arranged as a stack of multiple 2D memory device levels. As another non-limiting example, a 3D memory array may be arranged as multiple vertical columns (e.g., columns extending substantially perpendicular to the major surface of the substrate, such as in the y direction) with each column having multiple memory cells. The vertical columns may be arranged in a two-dimensional arrangement of memory cells, with memory cells on multiple vertically stacked memory planes. Other configurations of memory elements in three dimensions can also constitute a 3D memory array.

In another example, in a 3D NAND memory array, the memory elements may be coupled together to form vertical NAND strings that traverse across multiple horizontal memory device levels. Other 3D configurations can be envisioned wherein some NAND strings contain memory elements in a single memory level while other strings contain memory elements which span through multiple memory levels. 3D memory arrays may also be designed in a NOR configuration and in a ReRAM configuration.

Accordingly, examples of the present disclosure describe method, comprising: receiving a command; determining one or more characteristics associated with the command; based, at least in part, on the one or more characteristics, determining whether to route data associated with the command to a first encoding system associated with a controller of a data storage device or a second encoding system associated with the controller of the data storage device; based, at least in part, on routing the data to the first encoding system: generating a first logical to physical entry having a first fragment size; and storing the first logical to physical entry in a logical to physical mapping table; and based at least in part, on routing the data to the second encoding system: generating a second logical to physical entry having a second fragment size, wherein the second fragment size is less than the first fragment size; and storing the second logical to physical entry in the logical to physical mapping table. In an example, the first encoding system is a low-density parity check (LDPC) encoding system. In an example, the second encoding system is a Bose-Chaudhuri-Hocquenghem (BCH) encoding system. In an example, the first fragment size is four kilobytes (KB). In an example, the one or more characteristics are selected from a group of characteristics comprising: a logical block address associated with the command; an access requirement associated with the command; a PCIe transaction latency associated with the command; and on one or more hints provided by a host device. In an example, the method also includes storing the data in a first partition of the data storage device based, at least in part, on the data being routed to the first encoding system and storing the data in a second partition of the data storage device based, at least in part, on the data being routed to the second encoding system. In an example, the second partition includes one or more single-level cell memory blocks. In an example, the method also includes adjusting a cache reservation policy for the data when the data is routed to the second encoding system.

Examples also describe a data storage device, comprising: a controller; a first encoding system associated with the controller; a second encoding system associated with the controller; and a routing system associated with the controller, the routing system operable to: determine one or more characteristics associated with a received command; based, at least in part, on the one or more characteristics, determine whether to route data associated with the command to the first encoding system or the second encoding system; based, at least in part, on a determination to route the data to the first encoding system: generate a first logical to physical entry having a first fragment size; and store the first logical to physical entry in a logical to physical mapping table; and based at least in part, on a determination to route the data to the second encoding system: generate a second logical to physical entry having a second fragment size, wherein the second fragment size is less than the first fragment size; and store the second logical to physical entry in the logical to physical mapping table. In an example, the first encoding system is a low-density parity check (LDPC) encoding system. In an example, the second encoding system is a Bose-Chaudhuri-Hocquenghem (BCH) encoding system. In an example, the first fragment size is four kilobytes (KB). In an example, the one or more characteristics are selected from a group of characteristics comprising: a logical block address associated with the command; an access requirement associated with the command; a PCIe transaction latency associated with the command; and on one or more hints provided by a host device. In an example the routing system is further operable to store the data in a first partition of the data storage device based, at least in part, on the data being routed to the first encoding system and storing the data in a second partition of the data storage device based, at least in part, on the data being routed to the second encoding system. In an example, the routing system is further operable to adjust a cache reservation policy for the data when the data is routed to the second encoding system.

Examples also describe a data storage device, comprising: means for receiving a command; means for determining one or more characteristics associated with the command; means for determining whether to route data associated with the command to a first encoding system associated with a controller means or a second encoding system associated with the controller means; means for generating a first logical to physical entry having a first fragment size when the data is routed to the first encoding system; and means for generating a second logical to physical entry having a second fragment size when the data is routed to the second encoding system, wherein the second fragment size is less than the first fragment size. In an example, the first encoding system is a low-density parity check (LDPC) encoding system and wherein the second encoding system is a Bose-Chaudhuri-Hocquenghem (BCH) encoding system. In an example, the first fragment size is four kilobytes (KB). In an example, the one or more characteristics are selected from a group of characteristics comprising: a logical block address associated with the command; an access requirement associated with the command; a PCIe transaction latency associated with the command; and on one or more hints provided by a host device. In an example, the data storage device also includes means for adjusting a cache reservation policy for the data when the data is routed to the second encoding system.

One of ordinary skill in the art will recognize that the technology described herein is not limited to a single specific memory structure, but covers many relevant memory structures within the spirit and scope of the technology as described herein and as understood by one of ordinary skill in the art. One of skill in the art also will note that while the invention is described in terms of SLC and QLC memory blocks, in some embodiments, triple-level cell (TLC) memory blocks and multi-level cell (MLC) blocks may be substituted for QLC memory blocks.

The description and illustration of one or more aspects provided in the present disclosure are not intended to limit or restrict the scope of the disclosure in any way. The aspects, examples, and details provided in this disclosure are considered sufficient to convey possession and enable others to make and use the best mode of claimed disclosure.

The claimed disclosure should not be construed as being limited to any aspect, example, or detail provided in this disclosure. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Aspects of the present disclosure have been described above with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks. Additionally, it is contemplated that the flowcharts and/or aspects of the flowcharts may be combined and/or performed in any order.

References to an element herein using a designation such as “first,” “second,” and so forth does not generally limit the quantity or order of those elements. Rather, these designations may be used as a method of distinguishing between two or more elements or instances of an element. Thus, reference to first and second elements does not mean that only two elements may be used or that the first element precedes the second element. Additionally, unless otherwise stated, a set of elements may include one or more elements.

Terminology in the form of “at least one of A, B, or C” or “A, B, C, or any combination thereof” used in the description or the claims means “A or B or C or any combination of these elements.” For example, this terminology may include A, or B, or C, or A and B, or A and C, or A and B and C, or 2A, or 2B, or 2C, or 2A and B, and so on. As an additional example, “at least one of: A, B, or C” is intended to cover A, B, C, A-B, A-C, B-C, and A-B-C, as well as multiples of the same members. Likewise, “at least one of: A, B, and C” is intended to cover A, B, C, A-B, A-C, B-C, and A-B-C, as well as multiples of the same members.

Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

1. A method, comprising:
receiving a command;
determining one or more characteristics associated with the command;
based, at least in part, on the one or more characteristics, determining whether to route data associated with the command to a first encoding system associated with a controller of a data storage device or a second encoding system associated with the controller of the data storage device;
based, at least in part, on routing the data to the first encoding system:
generating a first logical to physical entry having a first fragment size, wherein a granularity of the first logical to physical entry is associated with the first encoding system; and
storing the first logical to physical entry in a logical to physical mapping table; and
based at least in part, on routing the data to the second encoding system:
generating a second logical to physical entry having a second fragment size, wherein the second fragment size is less than the first fragment size and wherein a granularity of the second logical to physical entry is associated with the second encoding system; and
storing the second logical to physical entry in the logical to physical mapping table.

2. The method of claim 1, wherein the first encoding system is a low-density parity check (LDPC) encoding system.

3. The method of claim 1, wherein the second encoding system is a Bose-Chaudhuri-Hocquenghem (BCH) encoding system.

4. The method of claim 1, wherein the first fragment size is four kilobytes (KB).

5. The method of claim 1, wherein the one or more characteristics are selected from a group of characteristics comprising: a logical block address associated with the command; an access requirement associated with the command; a PCIe transaction latency associated with the command; and one or more hints provided by a host device.

6. The method of claim 1, further comprising storing the data in a first partition of the data storage device based, at least in part, on the data being routed to the first encoding system and storing the data in a second partition of the data storage device based, at least in part, on the data being routed to the second encoding system.

7. The method of claim 6, wherein the second partition includes one or more single-level cell memory blocks.

8. The method of claim 1, further comprising adjusting a cache reservation policy for the data when the data is routed to the second encoding system.

9. A data storage device, comprising:
a controller;
a first encoding system associated with the controller;
a second encoding system associated with the controller; and
a routing system associated with the controller, the routing system operable to:
determine one or more characteristics associated with a received command;
based, at least in part, on the one or more characteristics, determine whether to route data associated with the command to the first encoding system or the second encoding system;
based, at least in part, on a determination to route the data to the first encoding system:
generate a first logical to physical entry having a first fragment size, wherein a granularity of the first logical to physical entry is associated with the first encoding system; and
store the first logical to physical entry in a logical to physical mapping table; and
based at least in part, on a determination to route the data to the second encoding system:
generate a second logical to physical entry having a second fragment size, wherein the second fragment size is less than the first fragment size and wherein a granularity of the second logical to physical entry is associated with the second encoding system; and
store the second logical to physical entry in the logical to physical mapping table.

10. The data storage device of claim 9, wherein the first encoding system is a low-density parity check (LDPC) encoding system.

11. The data storage device of claim 9, wherein the second encoding system is a Bose-Chaudhuri-Hocquenghem (BCH) encoding system.

12. The data storage device of claim 9, wherein the first fragment size is four kilobytes (KB).

13. The data storage device of claim 9, wherein the one or more characteristics are selected from a group of characteristics comprising: a logical block address associated with the command; an access requirement associated with the command; a PCIe transaction latency associated with the command; and one or more hints provided by a host device.

14. The data storage device of claim 9, wherein the routing system is further operable to store the data in a first partition of the data storage device based, at least in part, on the data being routed to the first encoding system and storing the data in a second partition of the data storage device based, at least in part, on the data being routed to the second encoding system.

15. The data storage device of claim 9, wherein the routing system is further operable to adjust a cache reservation policy for the data when the data is routed to the second encoding system.

16. A data storage device, comprising:
means for receiving a command;
means for determining one or more characteristics associated with the command;
means for determining whether to route data associated with the command to a first encoding system associated with a controller means or a second encoding system associated with the controller means;
means for generating a first logical to physical entry having a first fragment size when the data is routed to the first encoding system, wherein a granularity of the first logical to physical entry is associated with the first encoding system; and
means for generating a second logical to physical entry having a second fragment size when the data is routed to the second encoding system, wherein the second fragment size is less than the first fragment size and wherein a granularity of the second logical to physical entry is associated with the second encoding system.

17. The data storage device of claim 16, wherein the first encoding system is a low-density parity check (LDPC) encoding system and wherein the second encoding system is a Bose-Chaudhuri-Hocquenghem (BCH) encoding system.

18. The data storage device of claim 16, wherein the first fragment size is four kilobytes (KB).

19. The data storage device of claim 16, wherein the one or more characteristics are selected from a group of characteristics comprising: a logical block address associated with the command; an access requirement associated with the command; a PCIe transaction latency associated with the command; and one or more hints provided by a host device.

20. The data storage device of claim 16, further comprising means for adjusting a cache reservation policy for the data when the data is routed to the second encoding system.
